(19) United States
(12) Patent Application Publication
(10) Pub. No.: US 2022/0374740 A1
(43) Pub. Date: Nov. 24, 2022

(54) ARTIFICIAL INTELLIGENCE INFERENCE APPARATUS AND METHOD

(71) Applicant: Electronics and Telecommunications Research Institute, Daejion (KR)

(72) Inventors: Chang-Sik CHO, Daejeon (KR); Jae-Bok PARK, Daejeon (KR); Seung-Mok YOO, Daejeon (KR); Seok-Jin YOON, Daejeon (KR); Kyung-Hee LEE, Daejeon (KR)

(73) Assignee: Electronics and Telecommunications Research Institute, Daejeon (KR)

(21) Appl. No.: 17/767,364

(22) PCT Filed: Sep. 28, 2020
(86) PCT No.: PCT/KR2020/013250

§ 371 Date: Apr. 7, 2022

(30) Foreign Application Priority Data
Oct. 8, 2019 (KR) 10-2019-0124396
Sep. 18, 2020 (KR) 10-2020-0120585

(51) Int. Cl. G06N 5/04

(52) U.S. Cl. CPC G06N 5/04

(57) ABSTRACT

An embodiment relates to an artificial intelligence inference apparatus and method. The embodiment provides an artificial intelligence inference method, and may include converting an application based on a previously learned neural network into executable code in a high-level language independent of a learning framework, separating the executable code into General-Purpose Language (GPL) code and Domain-Specific Language (DSL) code depending on whether an acceleration operation is required, and generating target code optimized for hardware from the separated GPL code and DSL code.

### TECHNICAL FIELD

An embodiment relates to artificial-intelligence inference technology for executing a neural network in an embedded system environment.

### BACKGROUND ART

At home and abroad, research into deep learning technology based on artificial neural networks has been actively conducted, and the range of application thereof has expanded to various embedded environments, such as those of autonomous vehicles, unmanned moving objects, image-processing devices, and factory automation.

An application to which deep learning is applied is composed of a learning process and an inference process, and an inference system which actually enables trained deep learning in an embedded environment is implemented through a process for making a hardware device specialized for an artificial intelligence application and for configuring an inference engine and an application system in conformity with the made hardware device. During the process for making hardware, operation performance is improved by installing an accelerator for processing deep learning, and the inference engine is designed to be optimized for the corresponding hardware by including a deep-learning accelerator.

However, in this case, great cost can be incurred from the standpoint of reusability and maintenance of software and code, and thus there is a need to design an inference system which operates independently of hardware. In particular, in the case of an artificial intelligence application, a hardware environment is selected in consideration of a parallel computational load of artificial intelligence, wherein various types of acceleration hardware, such as a Central Processing Unit (CPU), a Graphics Processing Unit (GPU), a Field-Programmable Gate Array (FPGA), and a proprietary accelerator, are taken into consideration, and various types of accelerators, rather than just one type of accelerator, are occasionally used simultaneously. Since the inference system is designed in a structure that is dependent on various hardware acceleration hardware environments, a lot of time and effort is required every time it is required to construct a model optimized for a selected hardware environment.

### DISCLOSURE

### Technical Problem

An object of an embodiment is to easily implement an artificial intelligence application in an embedded system having various hardware environments.

Another object of the present invention is to minimize a change in an to inference engine depending on a change in hardware when the inference engine for accelerating deep learning is developed.

### Technical Solution

An embodiment provides an artificial intelligence inference method, and is includes converting an application based on a previously learned neural network into executable code in a high-level language independent of a learning framework, separating the executable code into General-Purpose Language (GPL) code and Domain-Specific Language (DSL) code depending on whether an acceleration operation is required, and generating target code optimized for hardware from the separated GPL code and DSL code.

Here, separating may be configured to generate the GPI, code and the DSL code from the executable code depending on whether the executable code is an operation-centered instruction as a result of analysis of the executable code.

Here, separating may be configured to check the executable code based on results of lexical analysis and syntax analysis when determining whether the executable code is an operation-centered instruction.

Here, generating the target code may be configured to generate the target code to be executed on a Central Processing Unit (CPU) of hardware from the GPL code.

Here, generating the target code may be configured to generate the target code to be executed on a CPU or an accelerator of hardware based on a result of analysis of the DSL code or a status of configuration of the accelerator of the hardware.

Here, generating the target code may be configured to generate the target code by applying DSL separation rules when the DSL code is beneficial for an acceleration environment as the result of analysis of the DSL code.

Here, generating the target code may be configured to generate the target code by applying DSL separation rules when an accelerator is present in the hardware.

Here, generating the target code may be configured to apply DSL separation rules for respective accelerator types when types of multiple accelerators in the hardware are different from each other.

Here, generating the target code may be configured to apply DSL separation rules for multiple accelerators in a homogeneous accelerator environment when multiple homogeneous accelerators are present in the hardware.

An embodiment provides an artificial intelligence inference apparatus, and includes a memory for storing at least one program, and a processor for executing the program, wherein the program may perform converting an application based on a previously learned neural network into executable code in a high-level language independent of a learning framework, separating the executable code into General-Purpose Language (GPL) code and Domain-Specific Language (DSL) code depending on whether an acceleration operation is required, and generating target code optimized for hardware from the separated GPL code and DSL code.

Here, separating may be configured to generate the GPL code and the DSL code from the executable code depending on whether the executable code is an operation-centered instruction as a result of analysis of the executable code.

Here, separating may be configured to check the executable code based on results of lexical analysis and syntax analysis when determining whether the executable code is an operation-centered instruction.

Here, generating the target code may be configured to generate the target code to be executed on a Central Processing Unit (CPU) of the hardware from the GPL code.

Here, generating the target code may be configured to generate the target code to be executed on a CPU or an accelerator of the hardware based on a result of analysis of the DSL code or a status of configuration of the accelerator of the hardware.

Here, generating the target code may be configured to generate the target code by applying DSL separation rules when the DSL code is beneficial for an acceleration environment as the result of analysis of the DSL code.

Here, generating the target code may be configured to generate the target code by applying DSL separation rules when an accelerator is present in the hardware.

Here, generating the target code may be configured to apply DSL separation rules for respective accelerator types when types of multiple accelerators in the hardware are different from each other.

Here, generating the target code may be configured to apply DSL separation rules for multiple accelerators in a homogeneous accelerator environment when multiple homogeneous accelerators are present in the hardware.

An artificial intelligence inference method according to an embodiment may include converting an application based on a previously learned neural network into executable code in a high-level language independent of a learning framework, separating the executable code into General-Purpose Language (GPL) code and Domain-Specific Language (DSL) code depending on whether an acceleration operation is required, and generating target code optimized for hardware from the separated GPL code and DSL code, wherein separating is configured to generate the GPL code and the DSL code from the executable code depending on whether the executable code is an operation-centered instruction as a result of analysis of the executable code, and wherein generating the target code is configured to generate the target code to be executed on a Central Processing Unit (CPU) of the hardware from the GPL code and to generate the target code to be executed on the CPU or an accelerator of the hardware based on a result of analysis of the DSL code or a status of configuration of the accelerator of the hardware.

Here, generating the target code may be configured to generate the target code by applying DSL separation rules when the DSL code is beneficial for an acceleration environment as the result of analysis of the DSL code and to generate the target code by applying the DSL separation rules when an accelerator is present in the hard ware.

### Advantageous Effects

The present invention proposes an artificial intelligence inference apparatus independent of various artificial intelligence applications and hardware acceleration environments, thus obtaining the advantages of reducing the time and effort required for development of embedded artificial intelligence and decreasing maintenance costs together with the time and effort.

### DESCRIPTION OF DRAWINGS

FIG. 1 is a schematic block configuration diagram of an embedded system including an artificial intelligence inference apparatus according to an embodiment;

FIG. 2 is a flowchart for explaining an artificial intelligence inference method according to an embodiment;

FIG. 3 is a flowchart for explaining step S220 of separating executable code illustrated in FIG. 2 into GPL code and DSL code;

FIG. 4 is a flowchart for explaining step S232 of generating target code from the DSL code illustrated in FIG. 2; and

FIG. 5 is a diagram illustrating the configuration of a computer system according to an embodiment.

### BEST MODE

Advantages and features of the present invention and methods for achieving the same will be clarified with reference to embodiments described later in detail together with the accompanying drawings. However, the present invention is capable of being implemented in various forms, and is not limited to the embodiments described later, and these embodiments are provided so that this invention will be thorough and complete and will fully convey the scope of the present invention to those skilled in the art. The present invention should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present invention.

The terms used in the present specification are merely used to describe embodiments and are not intended to limit the present invention. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present invention pertains. Further, terms defined in generally used dictionaries are not interpreted as having ideal or excessively formal meanings unless they are definitely defined in the present specification.

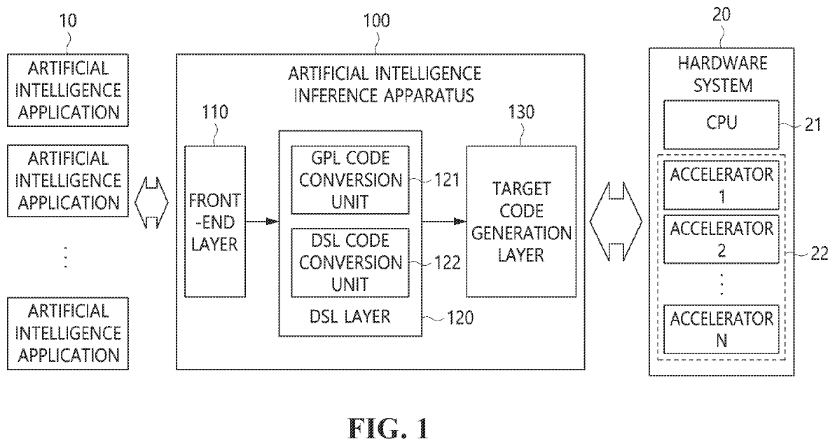

Hereinafter, an artificial intelligence inference apparatus and method that are operating in various hardware acceleration environments according to embodiments will be described in detail with reference to FIGS. 1 to 5.

Here, the artificial intelligence inference apparatus may be implemented as an embedded apparatus independent of various hardware acceleration environments. That is, the present invention proposes technology that enables the artificial intelligence inference apparatus to be easily ported to in various artificial intelligence hardware environments by separating a hardware-independent part into lower layers rather than newly constructing artificial intelligence inference apparatuses for various respective types of accelerators.

FIG. 1 is a schematic block configuration diagram of an embedded system including an artificial intelligence inference apparatus according to an embodiment.

Referring to FIG. 1, as program code for implementing various artificial intelligence applications 10 based on a previously learned neural network is input, an artificial intelligence inference apparatus 100 according to an embodiment enables the corresponding application program code to be executed in a state that is optimized for the characteristics of a hardware system 20.

Here, the neural network may be a deep-learning neural network, and many applications using the deep-learning neural network may, in advance, go through a learning process on a server. In this case, examples of a learning framework may include TensorFlow, Caffe, etc. Since the deep-learning neural network requires a large computational (operational) processing capacity, an acceleration device having excellent computation ability, such as a GPU or a dedicated accelerator, is required, and two or more homogeneous or heterogeneous accelerators may also be used depending on the circumstances.

However, because a learned neural network model and weight data are deployed in a form dependent on the learning framework, the artificial intelligence inference apparatus requires environment setting (configuration) identical to that of the learning framework, or must perform a procedure for converting the model and weight data into a format specialized for an inference engine. That is, since the existing inference system must implement a system that is dependent on specific hardware, an inference system must be newly constructed whenever acceleration hardware is changed. This greatly deteriorates the reusability of deep-learning acceleration code.

Therefore, the artificial intelligence inference apparatus 100 according to an embodiment is designed such that it is separated into a hardware-independent part and a hardware-dependent part and such that only the hardware-dependent part is newly constructed, even if the hardware environment is changed.

Accordingly, the artificial intelligence inference apparatus 100 according to the embodiment may include a front-end layer 110, a Domain-Specific Language (DSL) layer 120, and a target code generation layer 130.

The front-end layer 110 may convert an application based on a previously learned neural network and parameters into executable code in a high-level language independent of a learning framework. That is, each artificial intelligence application 10 is converted from code that is dependent on an artificial intelligence framework into code in a high-level language independent of the framework. That is, the front-end layer 110, which is a hardware-independent layer, may process, in common, pieces of data generated by various learning frameworks.

Here, the high-level language may be Python. Also, the high-level language may be a standardized deep-learning data exchange format, such as a Neural Network Exchange Format (NNEF) or an Open Neural Network eXchange format (ONNX).

The Domain-Specific Language (DSL) layer 120 may separate the executable code into General-Purpose Language (GPL) code and Domain-Specific Language (DSL) code depending on whether an acceleration operation is required. That is, the DSL layer 120 may convert the executable code generated by the front-end layer 110 into an artificial-intelligence processing routine independent of hardware using the DSL code.

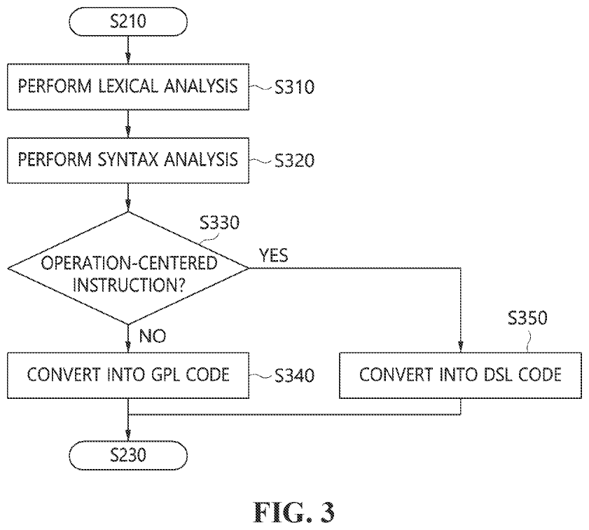

Here, the DSL layer 120 may generate GPL code and DSL code depending on whether the executable code is an operation-centered instruction as a result of analysis of the executable code. A detailed description thereof will be made later with reference to FIG. 3.

The target code generation layer 130 may generate target code optimized for hardware from the separated GPI: code and DSL code.

That is, the artificial intelligence application 10 is executed on the hardware system 20, wherein an accelerator 22 may be further installed together with a CPU 21. In this case, as the accelerator 22, various types of accelerators, such as a GPU, an FPGA, and a dedicated accelerator chip, may be installed, and there may be multiple homogenous accelerators. For example, the GPU and the accelerator chip may be simultaneously installed in the hardware system 20, or two identical GPUs may be installed. At this time, the acceleration environment setting of the hardware system 20 is implemented such that performance is optimized in consideration of size, power consumption, or the like in conformity with the characteristics of the artificial intelligence application.

On the CPU 21, GPI, code including C and C++ may typically be executed. Therefore, the target code generation layer 130 may generate target code to be executed on the CPU of the hardware from the GPL code.

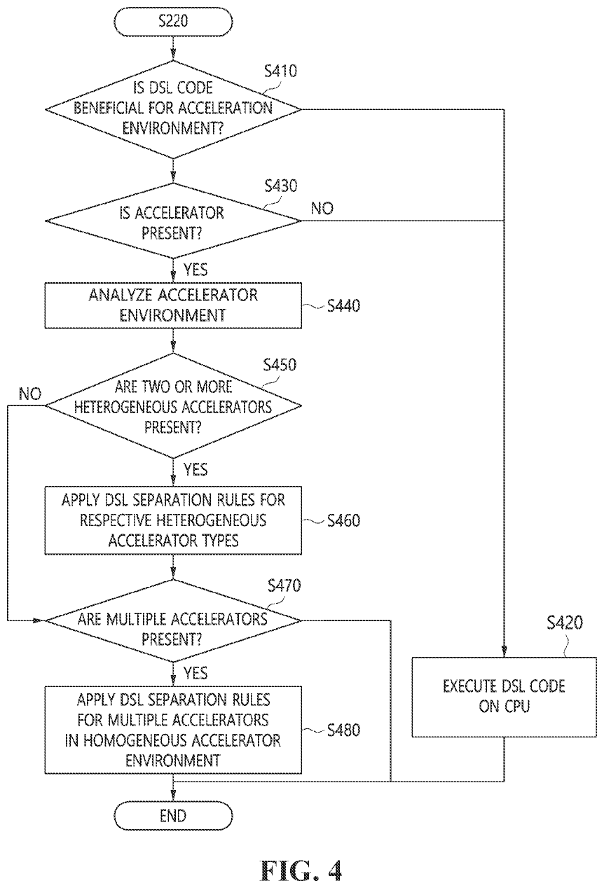

Further, the target code generation layer 130 may generate the target code to be executed on the CPU of the hardware or on the accelerator based on the result of analysis of the DSL code or the status of configuration of the accelerator of the hardware. On the accelerator 22, the DSL code may be executed, and may be converted into a form specialized for the accelerator. Also, depending on the characteristics of the DSL code, the DSL code may also be executed on the CPU 21. A detailed description thereof will be made later with reference to FIG. 4.

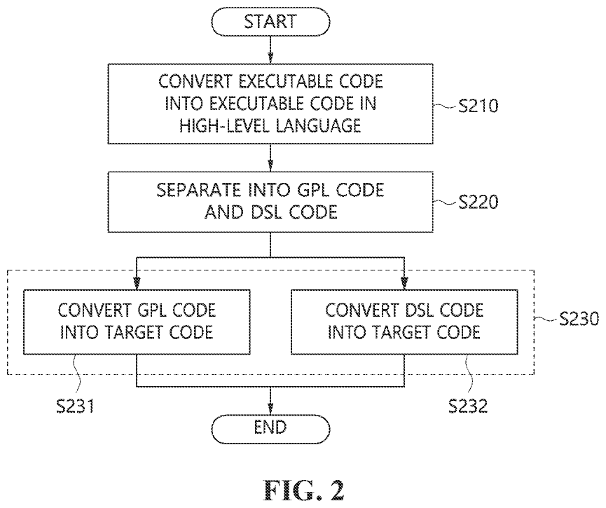

FIG. 2 is a flowchart for explaining an artificial intelligence inference method according to an embodiment.

Referring to FIG. 2, the embodiment relates to the artificial intelligence inference method, and may include step S210 of converting an application based on a previously learned neural network into executable code in a high-level language independent of a learning framework, step S220 (see FIG. 3) of separating the executable code into General-Purpose Language (GPL) code and Domain-Specific Language (DSL) code depending on whether an acceleration operation is required, and step S230 of generating target code optimized for hardware from the separated GPL code and DSL code.

Here, separation step S220 may generate the GPL code and the DSL code from the executable code depending on whether the executable code is an operation-centered instruction as a result of analysis of the executable code.

Here, separation step S220 may be configured to check the executable code based on the results of lexical analysis and syntax analysis when determining whether the executable code is an operation-centered instruction. A detailed description thereof will be made later with reference to FIG. 3.

Here, step S230 of generating the target code may include step S231 of generating the target code to be executed on the CPU of the hardware from the GPL code.

Here, step S230 of generating the target code may include step S232 of generating the target code to be executed on the CPU or the accelerator of hardware based on the results of analysis of the DSL code or the status of configuration of the accelerator of the hardware. That is, the artificial intelligence inference apparatus 100 converts the DSL language into target code so that it is optimized for a specific hardware environment. A detailed description thereof will be made later with reference to FIG. 4.

FIG. 3 is a flowchart for explaining step S220 of separating the executable code into the GPL code and the DSL code according to an embodiment.

Referring to FIG. 3, the apparatus 100 performs lexical analysis S310 and syntax analysis S320. Here, the term “lexical analysis” denotes splitting of each sentence of a program into tokens, which are minimum units. Here, the term “syntax analysis” denotes generation of a parse tree or a syntax tree from the tokens obtained at the lexical analysis step. In this case, as a result of the syntax analysis, variables, factor values, and array values are stored for the neural network using rules and an instruction database (DB) for a neural network framework.

Thereafter, the apparatus 100 determines, as a result of the analysis, whether the executable code is an operation-centered instruction at step S330. That is, based on a predefined rule, whether the executable code is an operation-centered instruction or a control-centered instruction is checked.

If it is determined at step S330 that the executable code is not an operation-centered instruction, the apparatus 100 generates GPL code from the executable code at step S340. That is, when the executable code is not a part that requires high performance implementation for an operation, the executable code is converted into the GPL code. For example, when an application is ‘face recognition’, code blocks corresponding to routines, such as camera driving, capturing, or image input, are not parts that require high performance implementation for operations, and thus the GPI, code is generated from the executable code.

In contrast, if it is determined at step S330 that the executable code is not an operation-centered instruction, the apparatus 100 generates DSL code from the executable code at step S350. That is, a part that requires high performance implementation for a deep-learning acceleration operation is converted into the DSL code. For example, when the application is ‘face recognition’, code blocks corresponding to a deep-learning neural network, which receives prepared data and is actually executed, are parts that require high performance implementation for operations, and thus the DSL code is generated from the executable code.

Here, DSL is defined by grammar and is designed in a language that optimally represents a Basic Linear Algebra Subprograms (BLAS) library. An example of DSL for accelerating deep learning may be given below.

C[i,j:M,N]=A(i,k:M,N)*+B(k,j:M,N)

FIG. 4 is a flowchart for explaining step S232 of generating the target code from the DSL code according to an embodiment.

In accordance with an embodiment, step S232 of generating the target code from the DSL code may be configured to generate the target code from the DSL code by applying DSL separation rules to the DSL code when the DSL code is beneficial for an acceleration environment as a result of analysis of the DSL code.

That is, referring to FIG. 4, the apparatus 100 determines, as a result of analysis of the DSL code, whether the DSL code is beneficial for an acceleration environment at step S410. If it is determined at step S410 that DSL code is not beneficial for the acceleration environment, the apparatus 100 generates the target code to be executed on the CPU from the DSL code at step S420, whereas if it is determined that the DSL code is beneficial for the acceleration environment, the process proceeds to step S430.

Also, in accordance with an embodiment, step S232 of generating the target code from the DSL code may be configured to generate the target code by applying DSL separation rules to the DSL code when an accelerator is present in hardware.

That is, referring to FIG. 4, the apparatus 100 determines whether an accelerator is present in the hardware at step S430. If it is determined at step S430 that no accelerator is present, the target code to be executed on the CPU is generated from the DSL code at step S420, whereas if it is determined that an accelerator is present, the process proceeds to step S440.

Further, in accordance with an embodiment, step S232 of generating the target code from the DSL code may be configured to apply DSL separation rules for respective accelerator types when the types of accelerators in the hardware are different from each other.

That is, referring to FIG. 4, the apparatus 100 analyzes the accelerator environment at step S440 and determines whether multiple heterogeneous accelerators of different types are present in the hardware at step S450. If it is determined at step 450 that multiple heterogeneous accelerators of different types are present, the apparatus 100 applies the DSL separation rules for respective accelerator types at step S460.

On the other hand, if it is determined at step S450 that multiple heterogeneous accelerators of different types are not present, or after step S460 has been performed, the apparatus 100 proceeds to step S470.

Furthermore, in accordance with an embodiment, step S232 of generating the target code from the DSL code may be configured to apply DSL separation rules for respective multiple accelerators in a homogeneous accelerator environment when multiple homogeneous accelerators are present in the hardware.

That is, referring to FIG. 4, the apparatus 100 determines whether multiple homogeneous accelerators are present in the hardware at step S470. If it is determined at step S470 that multiple homogeneous accelerators are present in the hardware, the apparatus 100 applies DSL separation rules for multiple accelerators in the homogeneous accelerator environment at step S480.

As described above, in an embodiment, a deep-learning execution part is converted into a part in an intermediate language using a DSL language, and generation of target code optimized for hardware in the DSL language is separated as a separate layer, and thus deployment of the inference system may be facilitated. In particular, the inference system has a structure that is easily operated even in an environment in which two or more acceleration hardware devices are present. Further, the artificial intelligence inference apparatus and method according to embodiments may be operated independently of various deep-learning acceleration devices (e.g., a CPU, a GPU, an FPGA, and a dedicated accelerator) when a deep-learning neural network is deployed in an embedded system environment.

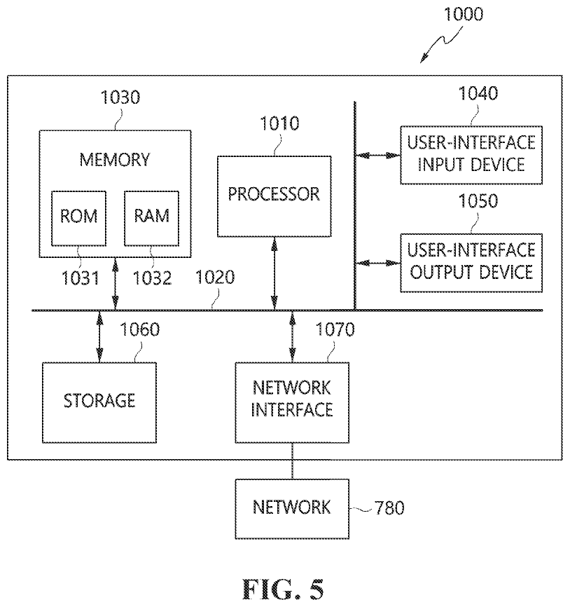

FIG. 5 is a diagram illustrating the configuration of a computer system according to an embodiment.

The artificial intelligence inference apparatus 100 according to an embodiment may be implemented in a computer system 1000, such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium, or an information delivery medium. For example, the memory 1030 may include Read-Only Memory (ROM) 1031 or Random Access Memory (RAM) 1032.

Although the embodiments of the present invention have been disclosed with reference to the attached drawing, those skilled in the art will appreciate that the present invention can be implemented in other concrete forms, without changing the technical spirit or essential features of the invention. Therefore, it should be understood that the foregoing embodiments are merely exemplary, rather than restrictive in all aspects.

1. An artificial intelligence inference method, comprising:
converting an application based on a previously learned neural network into executable code in a high-level language independent of a learning framework;
separating the executable code into General-Purpose Language (GPL) code and Domain-Specific Language (DSL) code depending on whether an acceleration operation is required; and
generating target code optimized for hardware from the separated GPL code and DSL code.

2. The artificial intelligence inference method of claim 1, wherein separating is configured to generate the GPL code and the DSL code from the executable code depending on whether the executable code is an operation-centered instruction as a result of analysis of the executable code.

3. The artificial intelligence inference method of claim 2, wherein separating is configured to check the executable code based on results of lexical analysis and syntax analysis when determining whether the executable code is an operation-centered instruction.

4. The artificial intelligence inference method of claim 1, wherein generating the target code is configured to generate the target code to be executed on a Central Processing Unit (CPU) of hardware from the GPI, code.

5. The artificial intelligence inference method of claim 1, wherein generating the target code is configured to generate the target code to be executed on a CPU or an accelerator of hardware based on a result of analysis of the DSL code or a status of configuration of the accelerator of the hardware.

6. The artificial intelligence inference method of claim 5, wherein generating the target code is configured to generate the target code by applying DSL separation rules when the DSL code is beneficial for an acceleration environment as the result of analysis of the DSL code.

7. The artificial intelligence inference method of claim 5, wherein generating the target code is configured to generate the target code by applying DSL separation rules when an accelerator is present in the hardware.

8. The artificial intelligence inference method of claim 7, wherein generating the target code is configured to apply DSL separation rules for respective accelerator types when types of multiple accelerators in the hardware are different from each other.

9. The artificial intelligence inference method of claim 7, wherein generating the target code is configured to apply DSL separation rules for multiple accelerators in a homogeneous accelerator environment when multiple homogeneous accelerators are present in the hardware.

10. An artificial intelligence inference apparatus, comprising:
a memory for storing at least one program; and
a processor for executing the program, wherein the program performs:
converting an application based on a previously learned neural network into executable code in a high-level language independent of a learning framework;
separating the executable code into General-Purpose Language (GPL) code and Domain-Specific Language (DSL) code depending on whether an acceleration operation is required; and
generating target code optimized for hardware from the separated GPL code and DSL code.

11. The artificial intelligence inference apparatus of claim 10, wherein separating is configured to generate the GPL code and the DSL code from the executable code depending on whether the executable code is an operation-centered instruction as a result of analysis of the executable code.

12. The artificial intelligence inference apparatus of claim 11, wherein separating is configured to check the executable code based on results of lexical analysis and syntax analysis when determining whether the executable code is an operation-centered instruction.

13. The artificial intelligence inference apparatus of claim 10, wherein generating the target code is configured to generate the target code to be executed on a Central Processing Unit (CPU) of the hardware from the GPL code.

14. The artificial intelligence inference apparatus of claim 10, wherein generating the target code is configured to generate the target code to be executed on a CPU or an accelerator of the hardware based on a result of analysis of the DSL code or a status of configuration of the accelerator of the hardware.

15. The artificial intelligence inference apparatus of claim 14, wherein generating the target code is configured to generate the target code by applying DSL separation rules when the DSL code is beneficial for an acceleration environment as the result of analysis of the DSL code.

16. The artificial intelligence inference apparatus of claim 14, wherein generating the target code is configured to generate the target code by applying DST separation rules when an accelerator is present in the hardware.

17. The artificial intelligence inference apparatus of claim 16, wherein generating the target code is configured to apply DSL separation rules for respective accelerator types when types of multiple accelerators in the hardware are different from each other.

18. The artificial intelligence inference apparatus of claim 16, wherein generating the target code is configured to apply DSL separation rules for multiple accelerators in a homogeneous accelerator environment when multiple homogeneous accelerators are present in the hardware.

19. An artificial intelligence inference method, comprising:
converting an application based on a previously learned neural network into executable code in a high-level language independent of a learning framework;
separating the executable code into General-Purpose Language (GPL) code and Domain-Specific Language (DSL) code depending on whether an acceleration operation is required; and
generating target code optimized for hardware from the separated GPL code and DSL code,
to wherein separating is configured to generate the GPL code and the DSL code from the executable code depending on whether the executable code is an operation-centered instruction as a result of analysis of the executable code, and
wherein generating the target code is configured to generate the target code to be executed on a Central Processing Unit (CPU) of the hardware from the GPL code and to generate the target code to be executed on the CPU or an accelerator of the hardware based on a result of analysis of the DSL code or a status of configuration of the accelerator of the hardware.

20. The artificial intelligence inference method of claim 19, wherein generating the target code is configured to generate the target code by applying DSL separation rules when the DSL code is beneficial for an acceleration environment as the result of analysis of the DSL code and to generate the target code by applying the DSL separation rules when an accelerator is present in the hardware.
